(19) United States
(12) Patent Application Publication
(10) Pub. No.: US 2006/0155781 A1
(43) Pub. Date: Jul. 13, 2006

(54) Systems and methods for structuring distributed fault-tolerant systems

(75) Inventors: John P. MacCormick, Mountain View, CA (US); Chandramohan A. Thekkath, Palo Alto, CA (US); Lidong Zhou, Sunnyvlae, CA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/032,374

(22) Filed: Jan. 10, 2005

(51) Int. Cl. G06F 17/30

(52) U.S. Cl. 707/202

(57) ABSTRACT

High-performance, scalable, and fault-tolerant distributed systems include decoupling data replication functions from reconfiguration and read functions to optimize system performance and provide a clean separation between scalability and fault tolerance. Each data object is replicated on multiple servers and a data replication protocol can be used to ensure data consistency. Read requests can be streamlined because any server can satisfy a read request, thus improving read performance, throughput, and overall system performance.

### FIELD OF THE INVENTION

The invention generally relates to distributed computer systems and more specifically to infrastructures for fault tolerant, distributed systems.

### BACKGROUND OF THE INVENTION

A server implementing a particular service can often be described as a deterministic state machine. The state machine maintains an internal state. For each command from a client, the state machine will deterministically transition from the current state to a new one and produce an output.

If a service is implemented by a single server, failure of that server may cause the service to fail. A standard approach to achieving fault tolerance is the replicated state machine approach, where the service is implemented by a set of servers, each implementing the same deterministic state machine. As long as the set of servers executes the same sequence of commands in the same order, the servers may maintain consistency. The agreement on the set of commands to be executed and the order in which they are executed can be reached through a consensus protocol.

In a large-scale reliable distributed system, each piece of data can be replicated on a set of servers. Different pieces may be replicated on different sets of servers. For each set of servers maintaining the same piece of data, a replicated state machine can be constructed with the data as the internal state.

FIG. 1 is a block diagram of a typical system 10 for providing consensus among data servers 20-23. The data servers 20-23 may be in communication with each other. Replicated data D1 resides on the data servers 20, 21. Replicated data D2 resides on the data servers 21, 22. Other replicated data (not shown) may also reside on the data servers 20-23. The replication may be performed by any method, such methods being known to those skilled in the art.

Each of the data servers 20-23 includes a respective consensus module 20C-23C. For any operation performed on the data residing on the data servers 20-23, the consensus modules 20C-23C may be invoked. The consensus modules 20C-23C may agree, for example, on the operations to be performed and the order in which the operations may be performed. To reach agreement, the consensus modules 20C-23C may perform a consensus protocol that may involve multiple rounds of communications among the servers before each command is committed and can thus be executed. At the conclusion of the protocol, each data server 20-23 may apply any necessary changes on the data residing on their respective server 20-23.

The consensus modules 20C-23C also may perform another function. In the event that a data server 20-23 fails or a new data server is added to the system 10, the consensus modules 20C-23C may reconfigure the system 10 so that the system 10 continues to provide distributed, fault tolerant, and reliable data. Such reconfiguration can be executed as commands that the servers reach consensus if the set of servers is part of the internal state maintained by the replicated state machine. The interactions between reconfigurations and continual executions of client commands often contribute to the complexity of consensus module reconfiguration.

While conceptually simple, the standard replicated state-machine approach has drawbacks. First, because the consensus module resides on every server in the system, any changes in the membership of data servers in the system may require a reconfiguration of the consensus module.

Additionally, while data is changed or updated more often than system membership changes occur, data is read far more often than data is changed or updated. The standard replicated state machine approach may make no distinction between read and write operations. Each read operation may go through the same commit process that requires multiple rounds of communication.

The operation is usually performed to assure that a predefined number of servers, such as a majority or a quorum, agree on the data, and only in this way is the data considered correct. If the data is in the process of being modified during the read operation, the data may still be read relatively quickly because the data replication protocol may ensure that a majority, quorum, etc., of data servers agree on the data.

Therefore, there is a need for replicated state-machine systems and methods that realistically reflect the operations required of it. The systems and methods desirably should decouple consensus module reconfiguration from system-wide membership changes, as well as decouple data replication and consensus.

### SUMMARY OF THE INVENTION

Aspects of the invention include an infrastructure for building high-performance, scalable, and fault-tolerant distributed systems. The infrastructure desirably provides a decoupling of data replication functions from reconfiguration functions. The consensus modules may be stand-alone consensus servers, logically separated from the data servers. The consensus servers are desirably responsible for the reconfiguration functions. In this way, the consensus modules may be separated from the critical path of system execution when no reconfigurations are required.

According to further aspects of the invention, the data servers may be responsible for data replication functions and no longer perform reconfiguration functions. The data servers may perform simpler data replication protocols (such as a two-phase commit protocol) because configuration is no longer wrapped in the replication function. The data replication protocol may apply updates on all data servers, and if a data server is unavailable (e.g., due to failure), the consensus service may be invoked to remove the unavailable server from the configuration of the replication group. The infrastructure not only may optimize system performance but also may provide a clean separation between scalability and fault tolerance. In this way the consensus function does not grow unnecessarily with the size of the system when scaling out.

Each data object is desirably replicated on multiple servers and a data replication protocol can be used to replicate data. Read requests can be streamlined because any server can satisfy a read request, allowing the read volume to be distributed among the data servers. That is, data may be read by reference to only one replica of the data without performing any data replication protocols. This significantly improves read performance, can increase throughput, and can improve overall system performance.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings example constructions of the invention; however, the invention is not limited to the specific methods and instrumentalities disclosed. In the drawings:

FIG. 1 is a block diagram of a typical distributed system for providing consensus among data servers;

FIG. 2 is a block diagram showing an example computing environment in which aspects of the invention may be implemented;

FIG. 3 is a block diagram of an example distributed system in accordance with an embodiment of the invention;

FIG. 4 is a block diagram of an example distributed system in accordance with an embodiment of the invention in which a data server has failed;

FIG. 5 is a flow diagram of an example method for configuring a distributed system in accordance with an embodiment of the invention when a data server on the system fails;

FIG. 6 is a block diagram of an example distributed system in accordance with an embodiment of the invention in which a data server has been added to the system; and

FIG. 7 is a flow diagram of an example method for configuring a distributed system in accordance with an embodiment of the invention when a data server is added to the system.

### DETAILED DESCRIPTION OF ILLUSTRATIVE EMBODIMENTS

Example Computing Environment

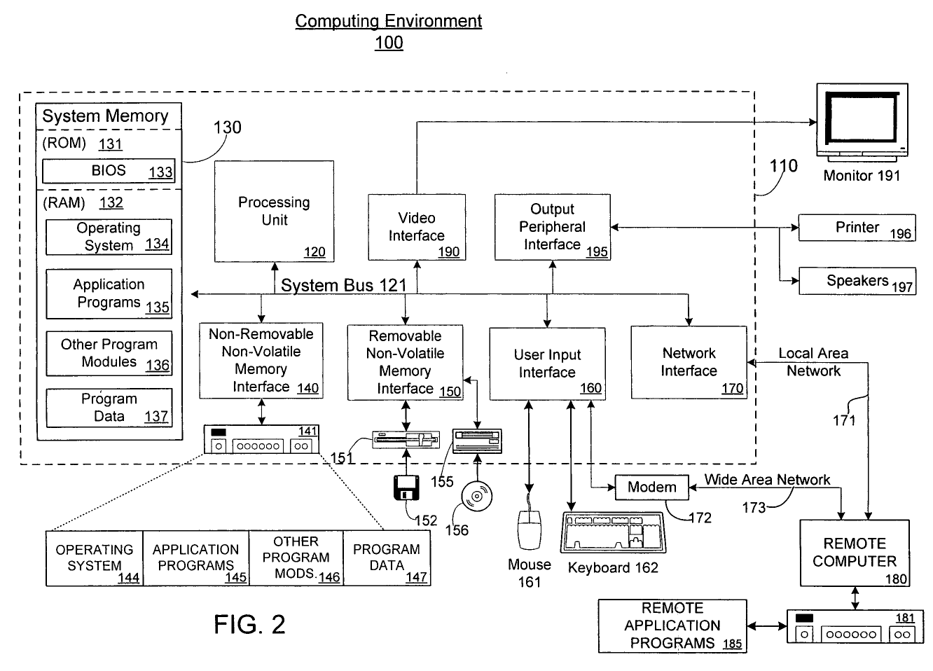

FIG. 2 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular objects or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where objects are performed by remote processing devices that are linked through a communications network or other data transmission medium. In a distributed computing environment, program modules may be located in both local and remote computer storage media including memory storage devices.

FIG. 2 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 2, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

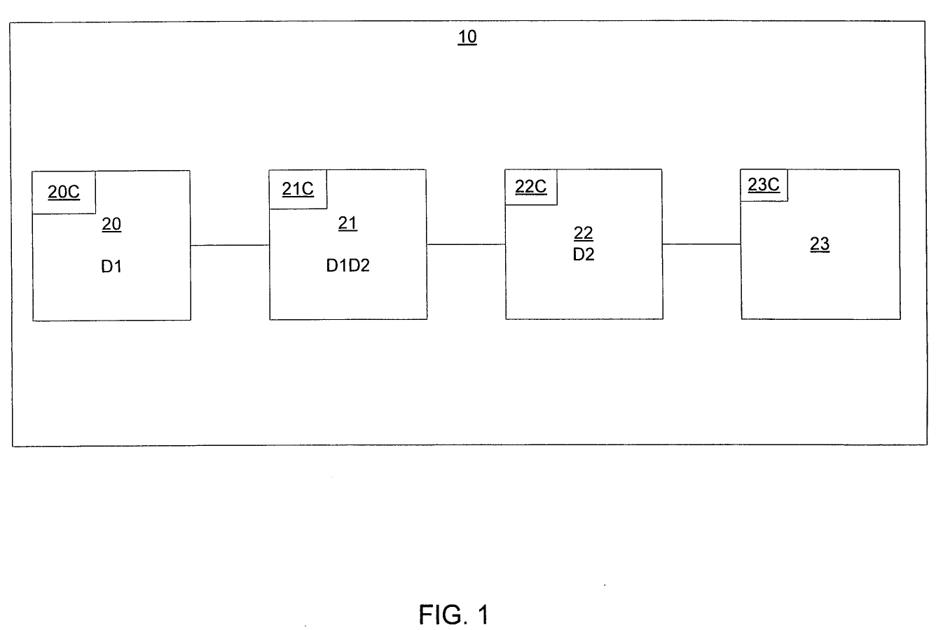

The drives and their associated computer storage media discussed above and illustrated in FIG. 2 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

Example Embodiments

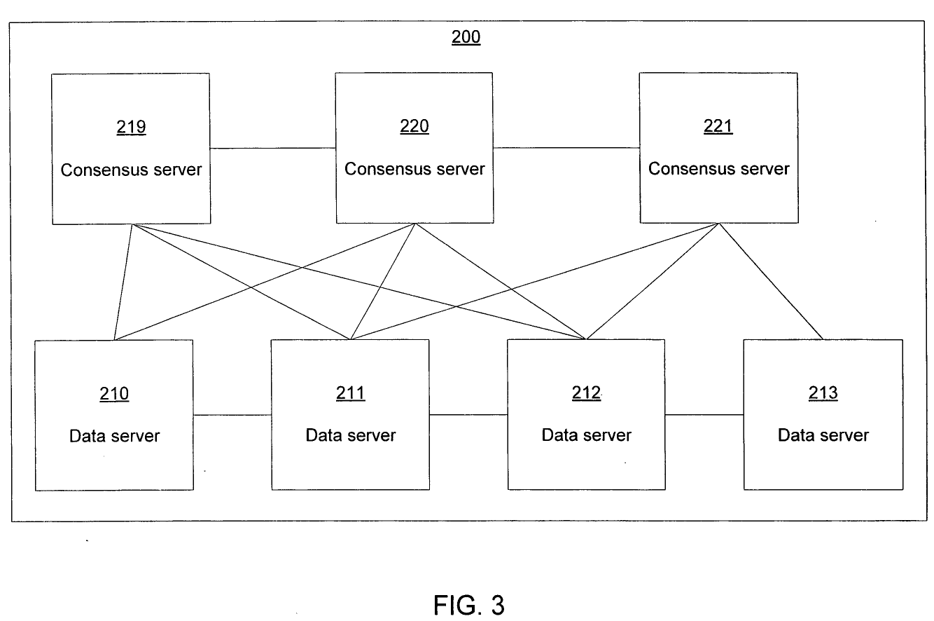

FIG. 3 is a block diagram of an example distributed fault-tolerant system 200 in accordance with the invention. The system 200 may reside on one or more computers 110 described with regard to FIG. 2. The system 200 may include consensus servers 219-221 and data servers 210-213.

The consensus servers 219-221 may be in communication with each other using either a wired or wireless connection and may be local or remote to each other, and may communicate via a network. Similarly, each of the consensus servers 219-221 may be in communication with one or more of the data servers 210-213 or may be in communication with any number of data servers. Each of the consensus servers 219-221 may be logically separated from the data servers 210-213 but may be physically located on one of the data servers 210-213 as a matter of convenience. The consensus servers 219-221 may be fewer in number than the data servers 210-213.

The consensus servers 219-221 may be invoked when the data server membership on the system 200 changes. That is, the state maintained by the consensus servers 219-221 may be the configuration of replicated groups, where each replicated group consists of a set of servers such as the data servers 210-213 maintaining copies of the same piece of data. When a data server 210-213 in the group fails or when a new data server is added to the system 200, the consensus servers 219-221 may be invoked to configure the data servers 210-213 to ensure all data servers 210-213 are aware of the change in membership.

The data servers 210-213, in addition to being in communication with the consensus servers 219-221 may be in communication with each other. Each piece of data of interest may be replicated on multiple data servers 210-213. The data servers 210-213 may perform operations on the data to ensure that the data remains reliable (e.g., the data is the same on each of the servers 210-213 where it is located). The data servers 210-213 may perform, for example, data replication protocols. Such an operation may include a two-way replication protocol if the distributed data storage system consists of two servers. A data replication protocol may be a multi-way replication protocol if the system comprises more than two servers. Such multi-way replication may be a three-phase commit protocol typically used in distributed storage systems. Alternatively, a two-phase commit or other protocol may be used for a data replication protocol.

With the separation of the typical consensus modules (e.g., elements 20C-23C in FIG. 1) from the typical data servers (e.g., elements 20-23 in FIG. 1) to form consensus servers 219-221 and data servers 210-213, two typical operations may be separated. One operation may be the configuration function regarding changes in the data server 210-213 membership in the system 200. This function ensures continued operation of the data servers 210-213 in the system 200 when a data server fails or is added to the system 200. The first operation is completed by the consensus servers 219-221. Another operation may be the data replication protocols occurring between the data servers 210-213. Such protocols may perform a data replication protocol that may ensure that the data servers 210-213 have a reliable copy of the data. This operation may involve, for example, a two-phase commit protocol and may be performed by the data servers 210-213. If the configuration of the system remains unaltered, with no change in the data server 210-213 membership in the system 200, then the data replication protocol (e.g., the two-phase commit protocol) may suffice in ensuring distributed, fault-tolerant, reliable consensus among the data servers 210-213.

Additionally, the replicated data stored on the data servers 210-213 may be read without requiring performance of a data replication protocol. Instead, one replica of data that is stored on multiple data servers 210-213 may be read without requiring a consensus operation.

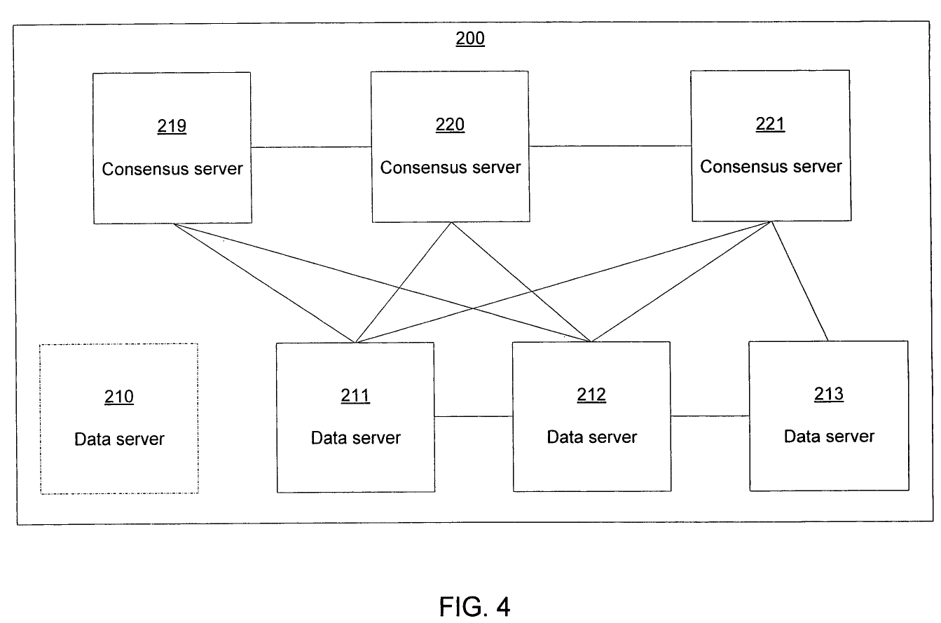

FIG. 4 depicts the system 200 in which a data server (e.g., data server 210) has failed. The data server 210 is no longer in communication with any of the remaining data servers 211-213 or with the consensus servers 219-221. The consensus servers 219-221 may reconfigure the system 200 so that when the data servers 211-213 perform data replication protocols, they no longer attempt to gain the consensus of data server 210.

For the consensus servers 219-221 to reconfigure the system 200, a notification may be provided to at least one of the consensus servers indicating that the data server 210 failed. The manner in which this notification is completed may be by any method, such notification methods being well known to those skilled in the art. For example, the notification may be the responsibility of the data server 211. That is, the data server 211 may be responsible for ensuring that the data replication protocols are carried out, and when the execution of the protocols is interrupted, the data server 211 may be responsible for alerting the consensus servers 219-221. The other data servers 210, 212, 213 may communicate with the data server 211 during data replication protocols.

If the data server 210 fails, then during performance of a data replication protocol, the data server 211 may not receive a response from the data server 210. This may cause a delay during which the data server 211 awaits a response from the data server 210. The delay may trigger the data server 211 to communicate with the consensus servers 219-221 to invoke a change operation in the configuration of the system 200 in recognition of the failure of the data server 210. The consensus servers 219-221 may reconfigure the system using, for example, a consensus protocol, ensuring that all servers agree on the configuration of the system 200. In this way, subsequent data replication protocols may be performed by the active membership of the system 200.

In the event that the data server 211 fails, then another data server such as the data server 212 may be responsible for performing the notification functions of the data server 211. Alternatively, in the event that the data server 211 fails, a reconfiguration may be triggered by other data servers in the replication group through any failure detection mechanism, such mechanisms being well known to those skilled in the art.

Of course, those skilled in the art will recognize that there are other mechanisms for detecting data server failures, and designation of a data server to notify consensus servers may be just one method of detecting data server failures or invoking changes to the configuration of the system 200.

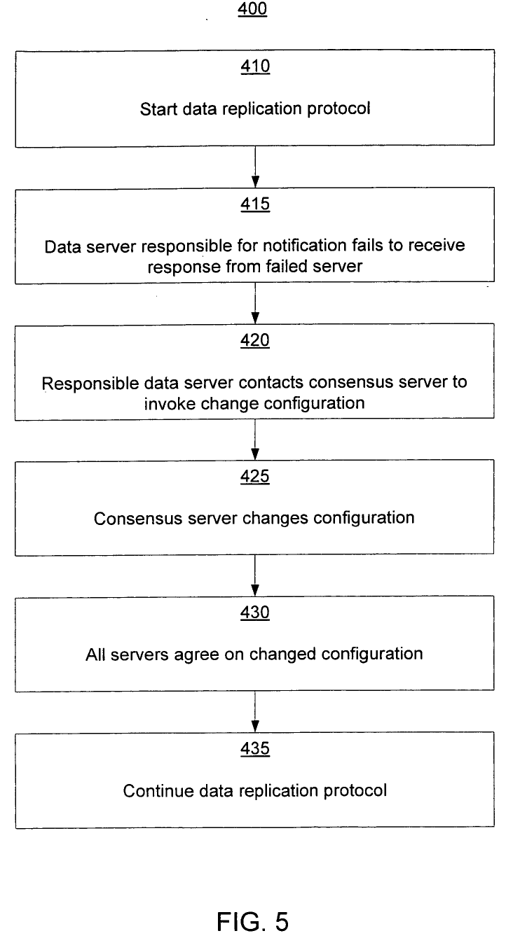

FIG. 5 is a flow diagram of an example method 400 for configuring a distributed system when a data server on the system fails, in accordance with the invention. Those skilled in the art will recognize that the example method 400 is just one way of configuring a system when a data server fails and that the embodiments herein described in no way limit the scope of the claimed invention. At step 410, the system may be performing a data replication protocol or some other operation during which it becomes apparent that a data server has failed. At step 415, a data server responsible for performing a notification function may expect to receive a response from the failed data server. At step 420, the responsible data server, after failing to receive a response from the failed server, may contact the consensus servers and invoke an operation to change the configuration of the system.

The consensus servers may then update the configuration of the system at step 425 to reflect the current data server membership. At step 430, the data server responsible for performing notification in the event of a server failure may notify other servers of the new membership, and the servers may agree on the new system configuration. The data servers may then continue with operations, such as data replication protocols at step 435.

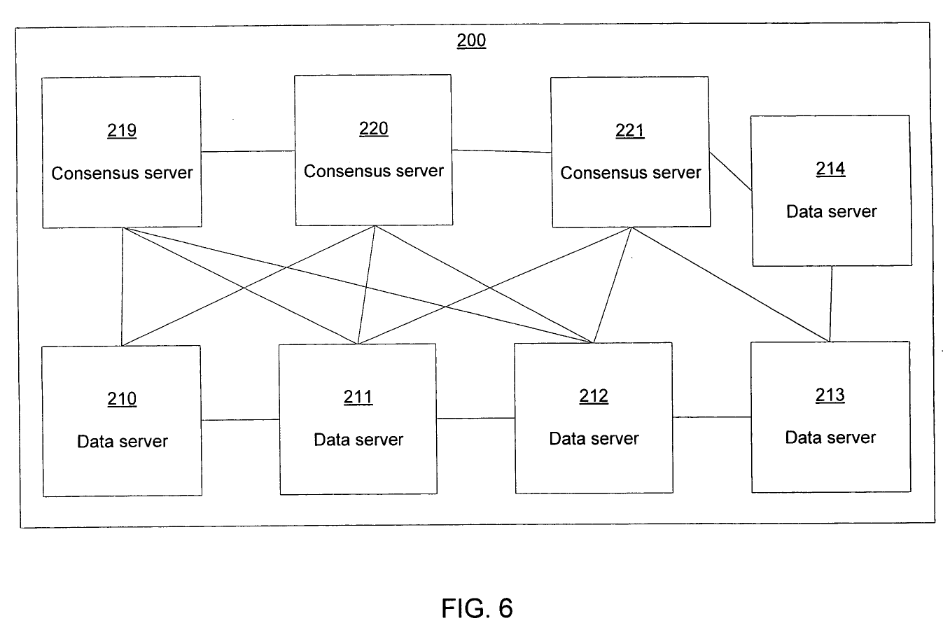

FIG. 6 depicts the system 200 in which a data server 214 has been added to the system 200. When the data server 214 is added to the system 200, it may contact the consensus servers 219-221 to invoke a change in the configuration of the system 200. Similar to when a data server fails, the consensus servers 219-221 may reconfigure the system, ensuring that all servers agree on the configuration of the system 200. In this way, subsequent data replication protocols may be performed and include the data servers 210-214.

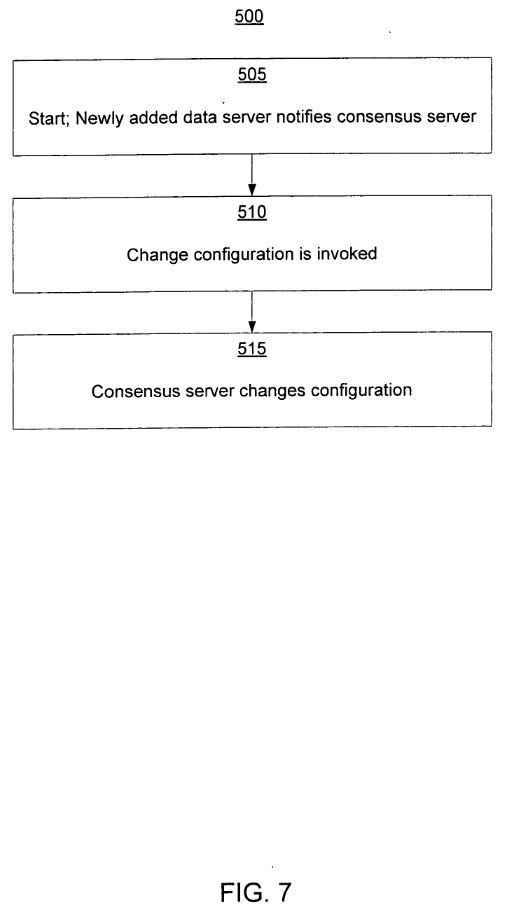

FIG. 7 is a flow diagram of a method 500 for configuring a distributed system when a data server is added to the system, in accordance with one embodiment of the invention. At step 505, the newly added data server may notify the consensus server of its presence. This notification may invoke, at step 510, a configuration change. Finally, at step 515, the consensus servers may change the configuration of the distributed system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models or aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and may be combined with hardware implementations.

While the present invention has been described in connection with the preferred embodiments of the various figures, it is to be understood that other embodiments may be used or modifications and additions may be made to the described embodiments for performing the same function of the present invention without deviating therefrom. In no way is the present invention limited to the examples provided and described herein. Therefore, the present invention should not be limited to any single embodiment, but rather should be construed in breadth and scope in accordance with the appended claims.

What is claimed:

1. A system, comprising:
a first data server having stored thereon first data; and
a second data server in communication with the first data server having stored thereon a replica of the first data, wherein modification of at least one of the first data and the replica of the first data is completed through a data replication protocol; and
wherein configuring the system is performed independent of the data replication protocol.

2. The system of claim 1, further comprising:
a consensus server in communication with at least one of the first and second data servers, wherein the consensus server participates in configuring the system.

3. The system of claim 2, wherein the consensus server participates in configuring the system when a third data server is added to the system.

4. The system of claim 2, wherein the consensus server participates in configuring the system when one of the first and second data server fails.

5. The system of claim 4, wherein the first data server invokes the consensus server to reconfigure the system.

6. The system of claim 1, wherein a read request involving the first data that is stored on the first data server is satisfied independent of involvement by the second data server.

7. The system of claim 1, wherein a read request involving the replica of the first data that is stored on the second data server is satisfied independent of involvement by the first data server.

8. The system of claim 1, wherein a read request involving the first data is satisfied independent of execution of the data replication protocol.

9. The system of claim 1, wherein the data replication protocol comprises a two-phase commit protocol.

10. The system of claim 1, wherein the data replication protocol comprises a multi-way replication protocol.

11. The system of claim 1, wherein the data replication protocol comprises a two-way replication protocol.

12. A method for changing a configuration of a distributed storage system, the system comprising a plurality of data servers participating in data replication protocols, the method comprising:
changing the configuration of the system to reflect the plurality of data servers, wherein the changing the configuration of the system is completed independent of execution of the data replication protocols.

13. The method of claim 12, further comprising:
obtaining consensus regarding the configuration from the plurality of data servers.

14. The method of claim 12, further comprising:
invoking a change in the configuration of the system.

15. The method of claim 14, wherein invoking the change in the configuration of the system is performed by one of the plurality of data servers in the system.

16. The method of claim 12, wherein changing the configuration of the system is performed by a consensus server, wherein the consensus server is logically independent of each of the plurality of data servers.

17. A computer-readable medium having computer-executable instructions for performing steps, comprising:
changing a configuration of a distributed storage system to reflect a plurality of data servers participating in data replication protocols in the system, wherein the changing the configuration of the system is completed independent of execution of the data replication protocols.

18. The computer-readable medium of claim 17, having further computer-executable instructions for performing the step of invoking the changing of the configuration of the system.

19. The computer readable medium of claim 18, wherein invoking the changing of the configuration of the system is performed by one of the plurality of data servers in the system.

20. The computer readable medium of claim 17, having further computer-executable instructions for performing the step of:
obtaining consensus regarding the configuration of the system from the plurality of data servers.
